(19) United States
(12) Patent Application Publication
(10) Pub. No.: US 2002/0005011 A1
(43) Pub. Date: Jan. 17, 2002

(54) Bottomless compartmentalized in-ground garden container

(76) Inventors: Lauri Goldberg, Kelowna (CA); David Goldberg, Kelowna (CA)

Correspondence Address: ANTONY C. EDWARDS, BISHOP & COMPANY, SUITE 206, 347 LEON AVENUE, KELOWNA, BC, V1Y 8C7, CA

(21) Appl. No.: 09/897,937

(22) Filed: Jul. 5, 2001

Related U.S. Application Data
(60) Provisional application No. 60/216,695, filed on Jul. 7, 2000.

(51) Int. Cl. A01G 9/02

(52) U.S. Cl. 47/65.5

(57) ABSTRACT

A bottomless compartmentalized in-ground garden container includes a rigid outer wall defining a perimeter and having opposite upper and lower edges around the perimeter. Rigid compartment walls extend at least partially across the perimeter. The compartment walls intersect the outer wall and other compartment walls so as to form compartments within the perimeter. The upper edge of the outer wall has a widened portion so as to have a thickness greater than a thickness of the lower edges of the outer wall and the compartment walls. The lower edges of the outer wall and the compartment walls are adapted to slice into soil. The widened portion is adapted for distributing pressure applied manually downwardly by a downward hand pressure onto the widened portion so as to drive the lower edges of the walls into the soil. The container is bottomless so as to leave the outer walls and the compartment walls exposed to soil forced upwardly into the compartments.

### CROSS REFERENCE TO RELATED APPLICATION

This application claims priority from U.S. Provisional Patent Application No. 60/216,695 filed Jul. 7, 2000 entitled Bottomless Compartmentalized In-Ground Garden Container.

### FIELD OF THE INVENTION

This invention relates to the field of garden containers such as flowerpots and the like generally, and in particular to a compartmentalized bottomless container for an in-ground garden.

### BACKGROUND OF THE INVENTION

It is often the case that in, for example, a residential setting, a gardener wishes to plant both perennials and annual herbs in an outdoor garden so as not to have to worry about individual watering of flowerpots or the like, but where because of inclement environmental conditions or because of the activity of other family members, such a garden is at risk of being damaged if it is not protected.

Consequently it is an object of the present invention to provide a bottomless compartmentalized in-ground garden container which may be inserted into the loosened soil of a conventional garden or flowerbed manually by the gardener with relative ease, and in furtherance of that object, to provide such a container where each compartment may have select varieties of plants with the soil in each compartment in which the soil may be tailored to the specific needs of the plants for example by adding specific fertilizers or ph modifying salts, etc. Further, for use with plants such as mint or oregano whose root systems may rapidly spread so as to invade the soil of neighboring plants, these types of plants may be contained within their own compartments and those compartments tailored to restrain root spread for example by the use of an elongated compartment and/or mesh-bottomed basket insert.

In the prior art applicant is aware of U.S. Pat. No. 3,164,507 which issued to Masuda on Jan. 5, 1965 for a Method of Making Cylinders for Raising and Transplanting Seedlings of Farm Crops. What is disclosed is the use of a honeycomb cell array which incorporates what appear to be open bottomed individual honeycomb cells in a multi-cellular two-dimensional array of such cells. It is neither taught nor suggested to use such a multi-cellular array adapted for ease of manual insertion into soil.

In the prior art applicant is also aware of more conventional planters such as that described in U.S. Pat. No. 3,310,910 which issued Mar. 28, 1967 to Titus for a Cast Planter and Canadian Pat. No. 647,797 which issued to Raab on Sep. 4, 1962 for a Seed Starter and Plant Propagator both of which prior art devices teach the use of a closed bottom container as conventionally found in planters.

### SUMMARY OF THE INVENTION

Without intending to be limiting, the bottomless compartmentalized garden container of the present invention may resemble a spoked wheel where each spoke corresponds to a radially extending compartment wall dividing adjacent compartments within the wheel. The depth of the compartments as defined by the compartment walls and the perimeter wall may be in the order of 6 inches deep, although, again, this is not intended to be limiting, but merely should be taken to indicate a convenient depth so that, with the soil loosened or excavated to a corresponding depth, substantially the entire container may be manually placed or depressed into the soil until the rim of the container is generally flush with the soil surface. To facilitate ease of manual insertion of the container into the loosened soil in the situation where a hole has not been excavated, the rim is widened or thickened and may have a rounded upper surface so as to provide a comfortable bearing surface upon which a gardener may press downwardly with his or her hands. This removes the requirement of the use of handheld tools such as mallets or the like to drive the container into the soil. The advantage of obviating the need for hand tools is to relieve the resultant high stress loading on the container walls which follows from the use of mallets or the like if used to drive the container downwardly into the soil. Such stresses might crack the plastic or other rigid material from which the container is constructed.

In keeping with the object to allow relative ease of insertion of the container partially or wholly into loosened soil, the lowermost edges of the compartment walls and the container perimeter wall may be tapered or otherwise sharpened so as to be wedge-shaped in cross-section.

In one preferred embodiment, a ventilated clear greenhouse bubble-shaped lid may be provided for snug removable mating of the lid onto the circumferential rim of the container. A tray may be provided to provide a sealing base under the compartments to allow use of the container as a portable greenhouse. Once plants have been started, the tray may be removed and the container placed into a correspondingly sized whole in soil so as to expose the roots in the compartments to the soil.

In embodiments in which the adjacent compartments are defined by radially extending compartment walls, a center or hub compartment may be defined by an inner encircling containment wall concentrically disposed relative to the outer perimeter wall of the container. Such a center compartment may effectively be extended to a deeper depth relative to the radial compartments (defined between the radially extending compartment walls in between the inner containment wall and the perimeter wall of the container) by adding a concentric inner tube so that plants having longer or more aggressively growing roots may be planted in the center compartment.

For example, the center compartment with the inner tube insert may extend telescopically downward 10 inches into the soil. If it is desired to insert a mesh-bottom into the center compartment so as to form a basket to further contain the root system of the plants to be planted there, the soil may be removed from the center compartment and a basket dropped down into the tubular cavity so as to rest against the soil floor. The soil for the center compartment is then refilled into the tubular cavity on top of the mesh bottom of the basket. Thus, as with the open bottomed compartments, the porous bottom of the basket provides for adequate soil drainage and for adequate wicking of moisture upwardly into the compartment.

Thus it may be seen that the bottomless garden container of the present invention may be used for the protected and untrammeled growing in an otherwise exposed bed of soil of fragile herbs and other plants, and also may be used as a plant nursery, or a tool for growing and transplanting of plants.

The bottomless garden container of the present invention may be adapted for ease of manual insertion into loosened soil, and in such an embodiment includes widened comfortable bearing surfaces for the application of hand or other downward pressure to the upper rim of the container. The container presents a reduced sidewall density relative to the space defined by the compartments so as to reduce the friction during insertion into soil generated as a function of the exposed sidewall surface areas (that is, a reduced wall surface area to open space plan view area ratio). Further, limiting the number of individual compartments alleviates the magnitude of the force required to depress the container into the soil. If the compartment openings are too small then soil would be pulled up with the compartments when the container was removed from the bed, as would be the case for example with the Masuda prior art device.

In summary the bottomless compartmentalized garden container of the present invention includes a rigid outer wall defining a perimeter and having opposite upper and lower edges around the perimeter. Rigid compartment walls extend at least partially across the perimeter. The compartment walls intersect the outer wall and other compartment walls so as to form compartments within the perimeter. The upper edge of the outer wall may have a widened portion so as to have a thickness greater than a thickness of the lower edges of the outer wall and the compartment walls. The lower edges of the outer wall and the compartment walls may be adapted to slice into soil. The widened portion may be adapted for distributing pressure applied manually downwardly by a downward hand pressure onto the widened portion so as to drive the lower edges of the walls into the soil. The container is bottomless so as to leave the outer walls and the compartment walls exposed to soil.

The outer wall and the compartment walls may be smooth sided so as to facilitate depressing the container into the soil by hand pressure, for example until the upper edges are generally flush with an upper surface of the soil.

The widened portion may be an annular rim. The rim may be generally round in cross section in a plane which is co-planar with a radially extending compartment wall. The radially extending compartment wall may extend radially from a centroidal axis of the container. The outer wall may be cylindrical. The outer wall may also be other shapes, for example in plan view, a radial segment of a circle, or, in plan view, a two-dimensional rectilinear body, or, in plan view, a segment of a two-dimensional rectilinear body. The two-dimensional rectilinear body may be a polygon.

A first contiguous array of the compartment walls may form a hub concentric with the outer wall. A second array of the compartment walls may form, in plan view, radial spokes extending radially of a centroidal axis of the container from the hub to the outer wall. Alternatively, a first compartment wall of the compartment walls forms a cylindrical hub concentric with the outer wall.

A light transmitting cover may be provided which is releasably mountable onto the upper edge of the outer wall. The cover may be a dome having at least one ventilation aperture therein. A removable bottom or tray may be provided for mounting under the compartments to allow the container to be used as a greenhouse or planter which may be buried along with soil and plants growing in the compartments.

The upper and lower edges of the outer wall and the compartment walls may be generally parallel. As an example, the upper edges may be co-planar and the lower edges may be co-planar. The container may be disc-shaped or shaped like a spoked wheel.

### BRIEF DESCRIPTION OF THE DRAWINGS

FIG. 1a is, in detailed cut away perspective view the container of the Bottomless Compartmentalized In-ground Garden Container of the present invention.

FIG. 1b is in perspective view the dome for the container of FIG. 1a.

FIG. 1c is the container of FIG. 1a with an optional basket insert mounted in the hub.

FIG. 1d is, in exploded view, a container, tray and lid according the present invention.

FIG. 2 is, in perspective view, the container of FIG. 1 with the rims removed.

FIG. 3 is, in plan view, the container of FIG. 2.

FIG. 4a is a sectional view along line 4a-4a in FIG. 6.

FIG. 4b is an isometric sectioned views through the auxiliary ring mount of FIGS. 1b and 6 respectively.

FIG. 5 is, in plan view, an alternative embodiment of the rim of the container of FIG. 1a.

FIG. 5a is an enlarged isometric cut away view of the rim of FIG. 5.

FIG. 6 is, in perspective view, an auxiliary ring for releasable mounting onto the ring of FIG. 5.

FIG. 7 is a conventional tomato ladder.

FIG. 8 is, in perspective view, an insert mesh-screen basket for mounting into the hub compartment of the container FIG. 1a.

FIG. 9 is, in exploded partially cut away view, the basket of FIG. 8.

FIGS. 10a-10h are, in plan view, alternative embodiments of the bottomless compartmentalized container of the present invention.

### DETAILED DESCRIPTION OF EMBODIMENTS OF THE INVENTION

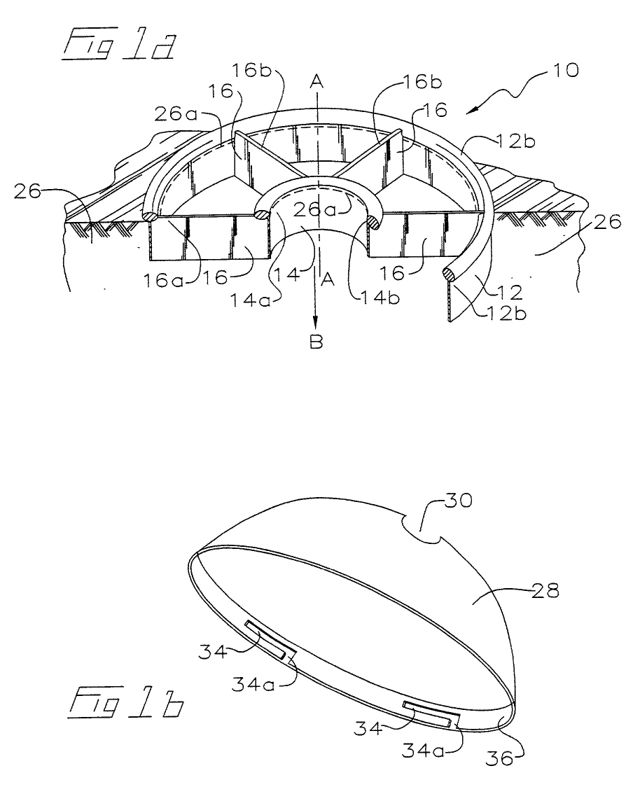

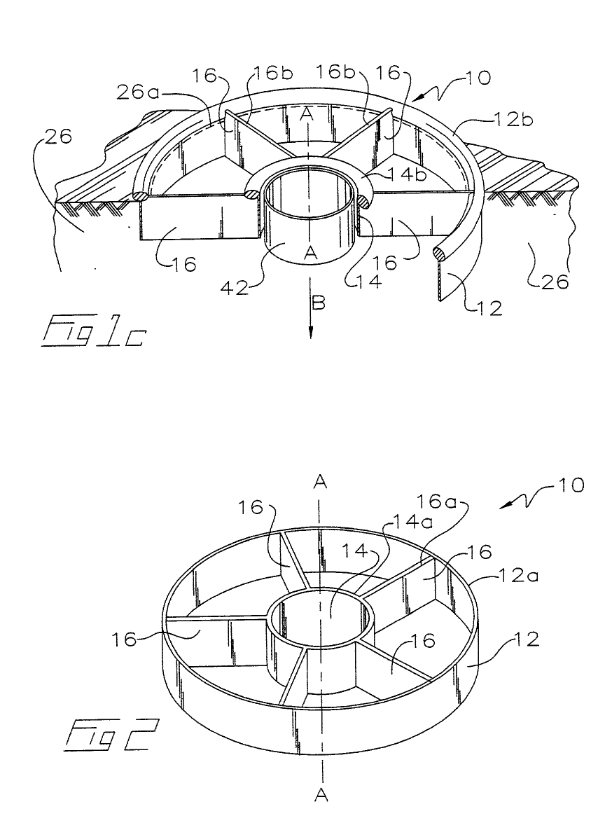

As seen in FIGS. 1a, 2 and 3, bottomless compartmentalized in-ground garden container 10 includes in one preferred embodiment perimeter wall 12, hub wall 14 and a radially spaced apart array of spoke or radial walls 16. The walls are generally vertically oriented. Hub wall 14 is concentric to perimeter wall 12, hub wall 14 having a radius in one embodiment, not intended to be limiting, of 5 inches and perimeter wall 12 having a radius, again not intended to be limiting, of 13 inches relative to axis of symmetry A. Consequently, radial wall 16, which extend radially outwardly of axis of symmetry A are each approximately 8 inches long.

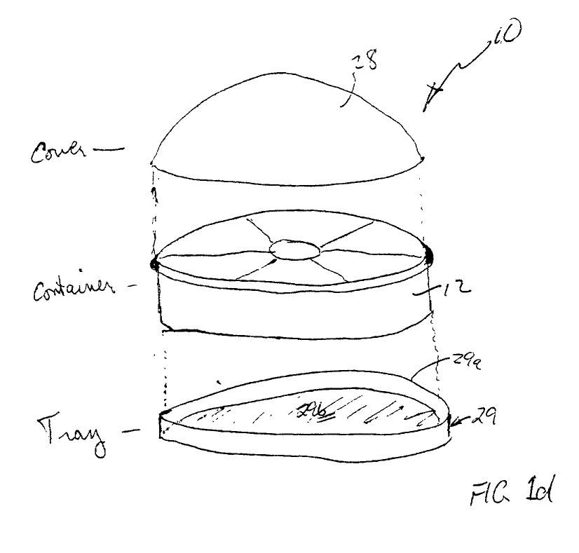

Each of the walls, being the perimeter wall, hub wall and radial walls may be made of plastic or other thin rigid material. The corresponding uppermost edges of the walls, namely, upper edges 12a, 14a and 16a of the perimeter wall, hub wall, and radial walls respectively as seen in FIG. 2 have widened corresponding rims 12b, 14b and 16b mounted or formed thereon as better seen in FIG. 1a and shown in cross-sectional detail in FIG. 5a. The rims are sufficiently wide so as to provide a smoothly rounded bearing surface around the uppermost edge of the rims or may have a generally planar land 18 as an uppermost surface extending between an innermost perimeter lip 20 slightly cantilevered over the void defined by the corresponding walls and a smoothly rounded outer perimeter surface 22. Inner perimeter surface 24 extends beneath inner perimeter edge 20 and one embodiment may merge smoothly with the inner surface of perimeter wall 12. Rim 14b may be formed similarly to rim 12b. Rims 16b may also be formed so as to provide widened bearing surfaces over their uppermost edge. The function of land 18 or other similarly widened bearing surface on the uppermost edges of the rims is to provide bearing surfaces when a user manually bears down against the rims so as to press container 10 into soil 26. Pressing container 10 in direction B into soil 26 forces the soil up into the apertures defined by the lowermost edges of the walls so as to fill the compartments with soil for example to the level indicated by dotted line 26a.

A clear plastic dome 28 such as seen in FIG. 1b may be provided as a lid which fits onto rim 12b for releasable sealing engagement thereon. Dome 28 produces a greenhouse effect underneath it and may be ventilated by either perforations (not shown) or by means of a single aperture 30. Dome 28 may be shaped so as to conformably fit onto rim 12b no matter whether container 10 is of the wheel design of FIGS. 1a, 2 and 3 or whether it is alternatively shaped as better described below. As seen in FIG. 1d, a tray 29 may also be provided. Perimeter wall 12 fits into the rim 29a of the tray so as to seat against the solid bottom floor 29b of the tray. The tray thus seals the underside of the compartments in the container so that the container may be used as a portable planter.

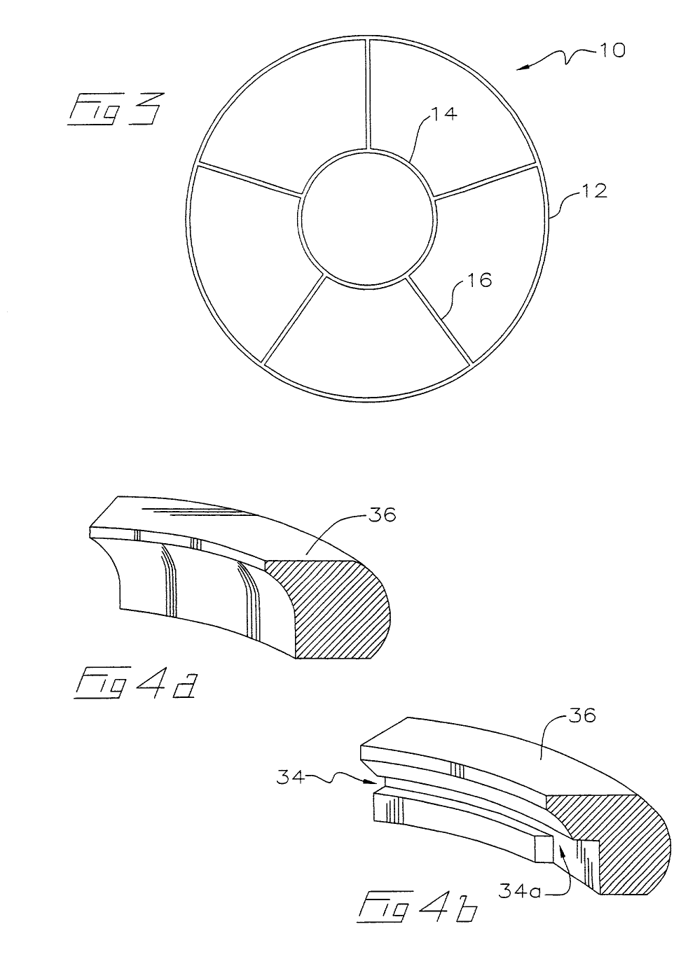

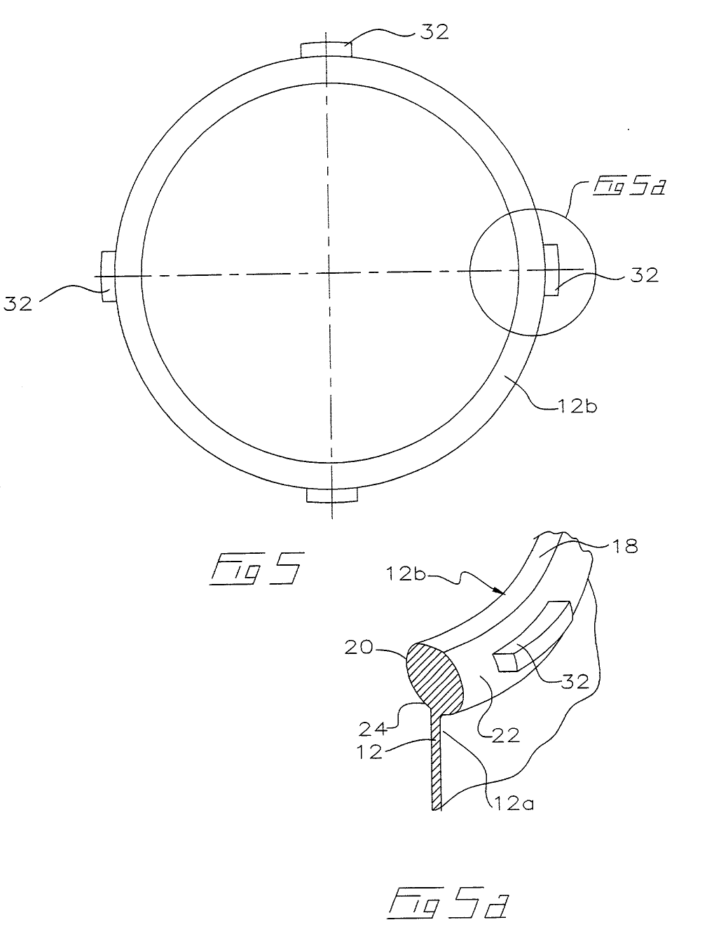

Tabs 32 are mounted to rim 12b in radially spaced apart relation so as to extend outwardly from the rim for sliding engagement with a corresponding slot 34 in ring mount 36. As seen in FIGS. 6 and 4b, auxiliary ring 36 may thus be releasably mounted onto rim 12b by engaging tabs 32 through slot keyways 34a into slots 34 and rotating the auxiliary ring so as to seat the tabs within a closed end of the slot opposite to the slot keyway 34a.

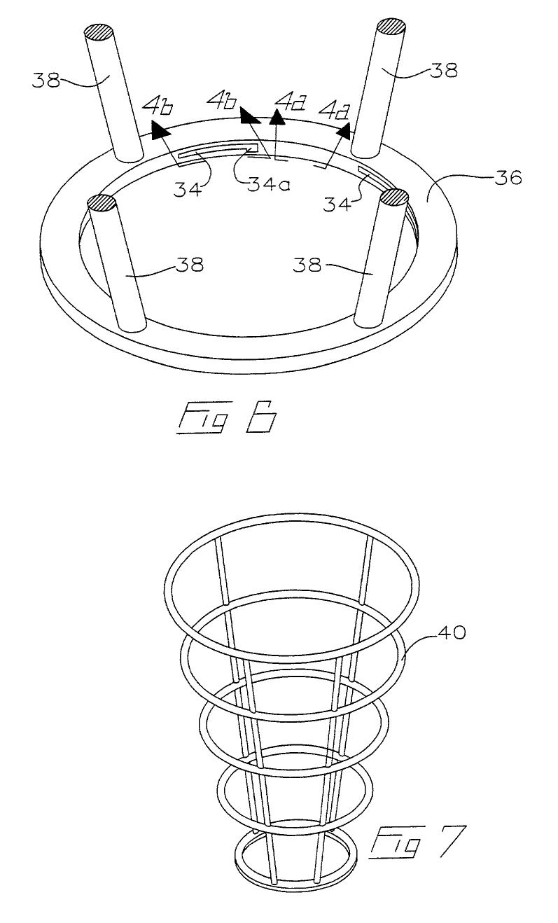

In FIG. 6, auxiliary ring 36 may have generally vertically extending posts 38 mounted in radially spaced array around the ring. Posts 38 provide vertically upstanding supports so that, the posts may be used to anchor plant supports such as tomato ladder 40 seen in FIG. 7.

An optional basket insert 42 seen in FIGS. 8 and 9, for sliding down into the hub compartment within hub wall 14, may be constructed of a cylindrical or annular collar 42a having an in-turned annular flange 42b. A water permeable mesh screen 46 (whose perimeter is shown in dotted outline in FIG. 9) is dropped down onto flange 42b. The screen may be mounted directly onto flange 42b. Basket 42 may be used to water permeably seal the lower aperture of the hub compartment for use for example with plants having aggressive root growth.

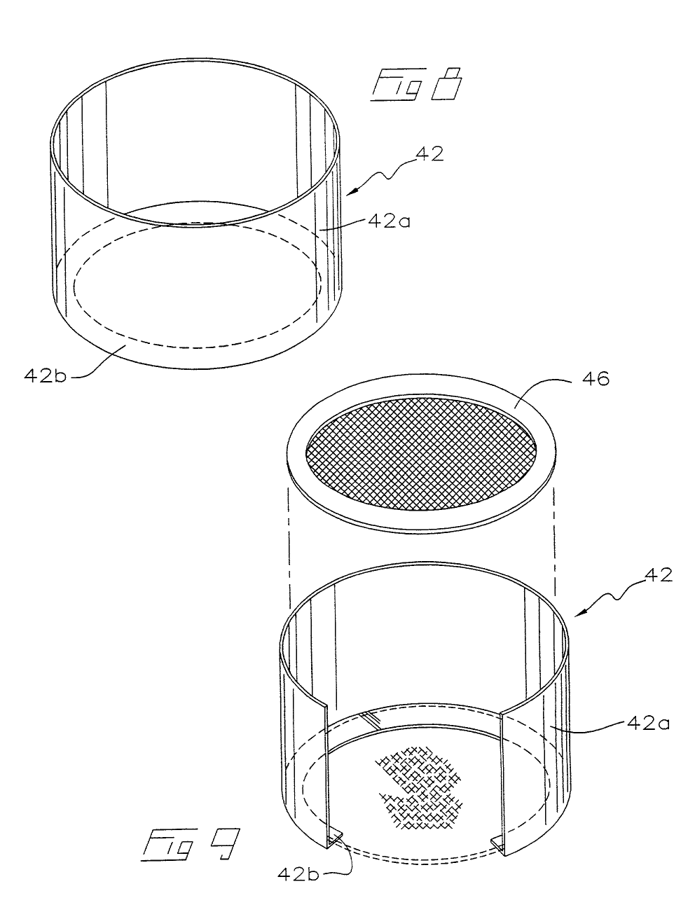

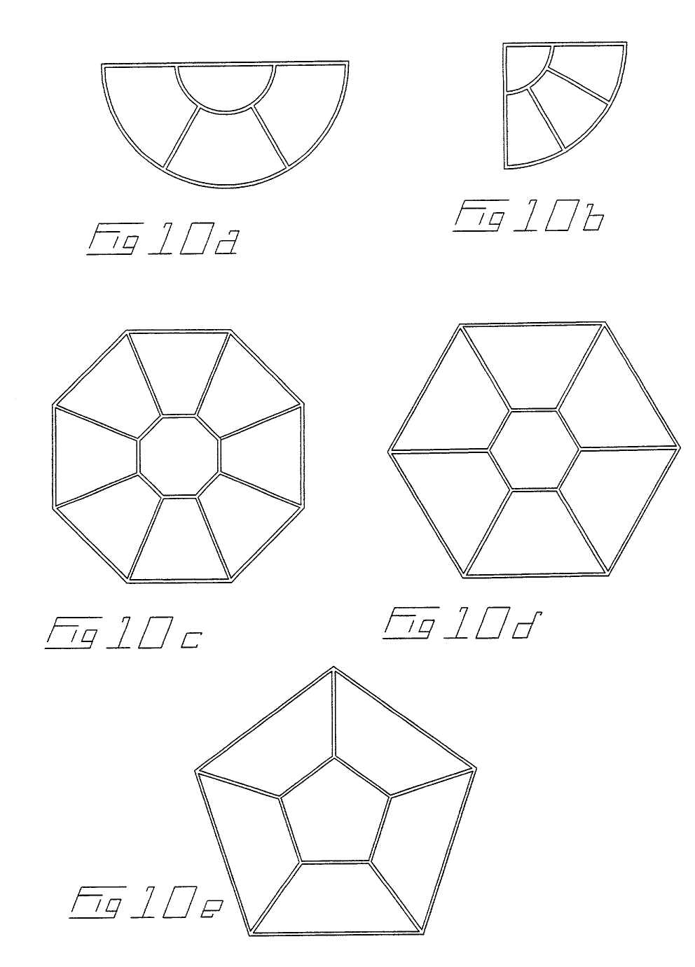

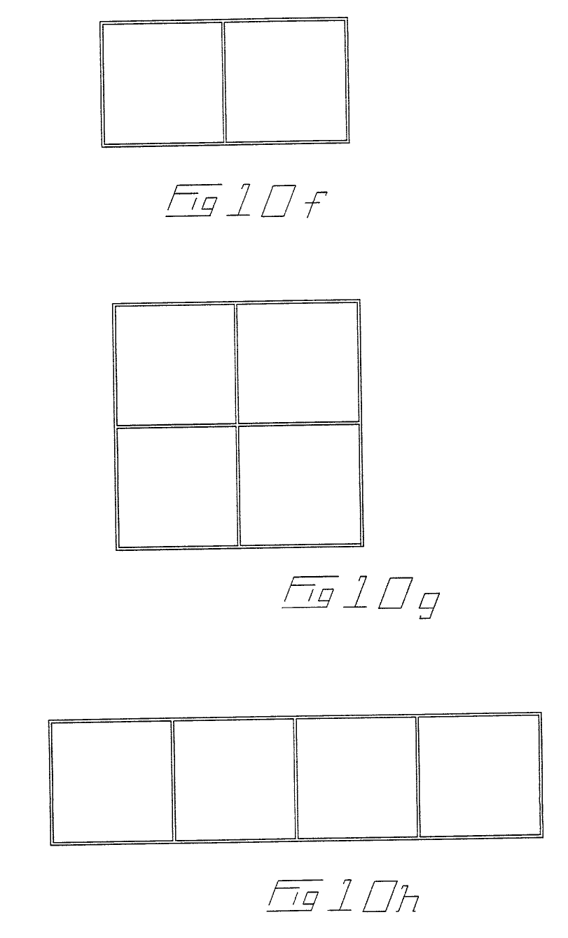

As seen in FIGS. 10a-10g, in alternative embodiments of the present invention the plurality of bottomless compartments may be formed within perimeter walls having a shape different from the wheel shape of FIG. 1. Thus the container may be formed as a radial segment of the container of FIG. 1 such as the half circle of FIG. 10a or the corner quadrant of the container of FIG. 10b. Alternatively, the perimeter wall may be, when viewed in plan view, generally any two dimensional rectilinear body exhibited by way of example in FIG. 10d as an octagon, in FIG. 10c as a hexagon, in FIG. 10g as a pentagon, and in FIGS. 10d and 10e as rectangles, and in FIG. 10f as a square. Within these perimeter walls, compartments of generally equal size are formed of shapes which, in the example of the rectilinear forms, may be accomplished by using planar partitioning walls. In the embodiments in which the perimeter wall is a polygon, a concentric hub which is shaped as a corresponding smaller polygon is positioned centrally with a radially spaced apart array of partitioning or segmenting walls extending between corresponding vertices of the concentrically nested polygons.

Where the perimeter wall is a parallelogram, the partitioning walls may extend either orthogonally between opposite walls or parallel between opposite walls, or both depending of whether the parallelogram is a rectangle, square or a rhombus (not shown).

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A bottomless compartmentalized in-ground garden container comprising:
a rigid outer wall defining a perimeter and having opposite upper and lower edges around said perimeter,
rigid compartment walls extending at least partially across said perimeter and intersecting so as to form compartments within said perimeter, said compartment walls having opposite upper and lower edges,
said upper edge of said outer wall having a widened portion so as to have a thickness greater than a thickness of said lower edges of said outer wall and said compartment walls,
and wherein said container is bottomless.

2. The container of claim 1 wherein said widened portion is an annular rim.

3. The container of claim 2 wherein said rim is generally round in cross section in a plane which is co-planar with a radially extending compartment wall of said compartment walls, said radially extending compartment wall extending radially from a centroidal axis of said container.

4. The container of claim 1 wherein said outer wall is cylindrical and said widened portion is an annular rim.

5. The container of claim 1 wherein said outer wall is, in plan view, a radial segment of a circle, and said widened portion is a rim.

6. The container of claim 1 wherein said outer wall is, in plan view, a two-dimensional rectilinear body, and said widened portion is a rim.

7. The container of claim 1 wherein said outer wall is, in plan view, a segment of a two-dimensional rectilinear body, and said widened portion is a rim.

8. The container of claim 6 wherein said two-dimensional rectilinear body is a polygon.

9. The container of claim 8 wherein said polygon is a hexagon.

10. The container of claim 8 wherein said polygon is a pentagon.

11. The container of claim 8 wherein said polygon is a rectangle.

12. The container of claim 8 wherein said polygon is an octagon.

13. The container of claim 8 wherein a first contiguous array of said compartment walls forms a hub concentric with said outer wall, and wherein a second array of said compartment walls form, in plan view, radial spokes extending radially of a centroidal axis of said container from said hub to said outer wall.

14. The container of claim 4 wherein a first compartment wall of said compartment walls forms a hub concentric with said outer wall, and wherein a second array of said compartment walls form, in plan view, radial spokes extending radially of a centroidal axis of said container from said hub to said outer wall.

15. The container of claim 1 further comprising a light transmitting cover releasably mountable onto said upper edge of said outer wall.

16. The container of claim 15 wherein said cover is a dome having at least one ventilation aperture therein.

17. The container of claim 1 wherein said upper and lower edges of said outer wall and said compartment walls are generally parallel.

18. The container of claim 17 wherein said upper edges are co-planar and said lower edges are co-planar.

19. The container of claim 1 wherein said container is disc-shaped.

20. The container of claim 1 wherein said container is shaped like a spoked wheel.

21. The container of claim 1 further comprising a solid bottom tray mountable to said lower edge of said perimeter of said outer wall for sealing said compartments to contain soil for out-of-ground use of said container as a planter.

22. The container of claim 1 wherein said outer wall and said compartment walls are smooth sided so as to allow depressing said container into said soil by hand pressure until said upper edges are generally flush with an upper surface of said loosened soil.

23. The container of claim 1 wherein said widened portion is adapted for distributing pressure applied onto said widened portion.
